(19) United States
(12) Patent Application Publication
(10) Pub. No.: US 2012/0129079 A1
(43) Pub. Date: May 24, 2012

(54) HIGH DIFFERENTIAL PRESSURE ELECTROCHEMICAL CELL COMPRISING A SPECIFIC MEMBRANE

(75) Inventors: Erik Middelman, Arnhem (NL); Marleen Middelman-Koornneef, Arnhem (NL)

(73) Assignee: HYET HOLDING B.V., Arnhem (NL)

(21) Appl. No.: 13/148,667

(22) PCT Filed: Feb. 15, 2010
(86) PCT No.: PCT/EP2010/051864

§ 371 Date: Nov. 22, 2011

(30) Foreign Application Priority Data
Feb. 16, 2009 (EP) 09152913.1
Feb. 16, 2009 (EP) 09152946.1

(51) Int. Cl. H01M 8/10; C25B 1/02; C25B 1/12; C25B 9/00

(52) U.S. Cl. 429/505; 204/252; 205/343; 205/629

(57) ABSTRACT

The present invention pertains to a high differential pressure electrochemical cell which encompasses a high pressure chamber and a low pressure chamber, said chambers being separated by a membrane, the membrane being ion-conductive, in particular proton-conductive, and electrically insulating, the membrane having a first surface in the high pressure chamber and a second surface in the low pressure chamber, the first surface being provided with a first electrode, and the second surface being provided with a second electrode, the first and second electrodes being electroconductively connected to each other via an electric circuit, wherein the membrane comprises at least two ion-conductive layers, wherein at least one of said ion-conductive layers is electrically insulating and at least one of said ion-conductive layers is electrically conductive. The high differential pressure electrochemical cell preferably is an ionic gas compressor, an ionic gas decompressor, or a high pressure electrolyser.

The invention relates to high differential pressure electrochemical cells such as ionic gas compressors, ionic gas decompressors and high pressure electrolysers, more particularly, to high differential pressure electrochemical cells comprising a membrane electrode assembly provided with a membrane showing improved resistance to reactant crossover.

Ion-conductive membranes, in particular proton-conductive membranes are known in the art. In general, on one side of the membrane, a hydrogen-containing molecule, for example water or molecular hydrogen is converted to form protons, electrons, and optionally other gases, using a catalytic material. The protons are transported through the membrane, while the electrons are removed through an electrode present on the membrane. The electrons are passed through an external circuit, and fed to an electrode present on the other side of the membrane where they react with protons, and optionally other components like oxygen, to form molecular hydrogen, water, or other compounds, depending on the application.

Ion-conductive membranes are used in various high differential pressure electrochemical cells. For an example, they are used in ionic gas compressors. At the anode side of an ionic gas compressor hydrogen is reacted to form electrons and protons. The protons pass through the membrane, and react at the cathode with electrons to form molecular hydrogen. In this way ionic gas compressors pump hydrogen from low pressure to an increased pressure using electrical energy.

Ion-conductive membranes are also used in ionic gas decompressors. In an ionic gas decompressor the working principle of an ionic gas compressor is reversed so that compression energy stored in the high pressure gas is harvested as the gas flows from high pressure to low pressure.

In yet another application ion-conductive membranes are also used in high differential pressure electrolysers. At the anode side of an electrolyser water is reacted to form oxygen gas and protons. The protons pass through the membrane, and react at the cathode with electrons to form molecular hydrogen. In this way electrolysers convert water into hydrogen and oxygen.

US 2004/0028965 discloses a fuel cell system comprising an electrochemical cell, which is used to transfer hydrogen from storage vessel with a high hydrogen concentration to a hydrogen flow circuit with a lower hydrogen concentration, and the other way around. However, in this prior art system, the pressure difference over the transfer cell is limited. The used materials and the stack construction of the hydrogen transfer cells are not suitable for use with high pressure differences. A separate compressor is required to further pressurize the hydrogen transferred to the storage vessel.

It has been found that in high differential pressure electrochemical cells reactant crossover may be a substantial problem due to the high pressure differential applied. Reactant crossover will lead to a decrease in yield of the electrochemical cell. There is therefore need in the art for improved ion-conductive membranes for application in high differential pressure electrochemical cells, in particular, for membranes with a good permeability for protons, but which show a low permeability for molecular gases, such as molecular hydrogen or molecular oxygen.

It is a primary object of the present invention to provide a high differential pressure electrochemical, cell comprising a membrane which is less susceptible to the crossover of molecular gases such as oxygen or hydrogen, without the ion permeability of the membrane being detrimentally affected.

It is another object of the present invention to provide an ion-conductive membrane suitable for use in said application. The membrane should on the one hand show reduced reactant crossover, and on the other hand should be able to withstand a substantial differential pressure.

It is a further object of the invention to provide an ionic gas compressor, an ionic gas decompressor and a high pressure electrolyser apparatus with increased efficiency and improved durability.

It has been found that these objects are accomplished by the various aspects of the present invention, as will, be elucidated in more detail below.

The present invention provides a high differential pressure electrochemical cell which encompasses a high pressure chamber and a low pressure chamber, said chambers being separated by a membrane, the membrane being ion-conductive, in particular proton-conductive, and electrically insulating, the membrane having a first surface in the high pressure chamber and a second surface in the low pressure chamber, the first surface being provided with a first electrode, and the second surface being provided with a second electrode, the first and second electrodes being electroconductively connected to each other via an electric circuit, wherein the membrane comprises at least two ion-conductive layers, wherein at least one of said ion-conductive layers is electrically insulating and at least one of said ion-conductive layers is electrically conductive.

The present invention also provides a membrane suitable for use in a high differential pressure electrochemical cell the membrane being ion-conductive, in particular proton-conductive, and electrically insulating, wherein the membrane comprises at least two ion-conductive layers, wherein at least one of said ion-conductive layers is electrically insulating and at least one of said ion-conductive layers is electrically conductive.

The present invention further provides the use of a membrane specified herein in a high differential pressure electrochemical cell.

The present invention will be discussed in more detail below, with references to the attached drawings, which schematically show preferred embodiments according to the invention. It will be understood that the invention is not in any way restricted to these specific and preferred embodiments.

In the drawings:

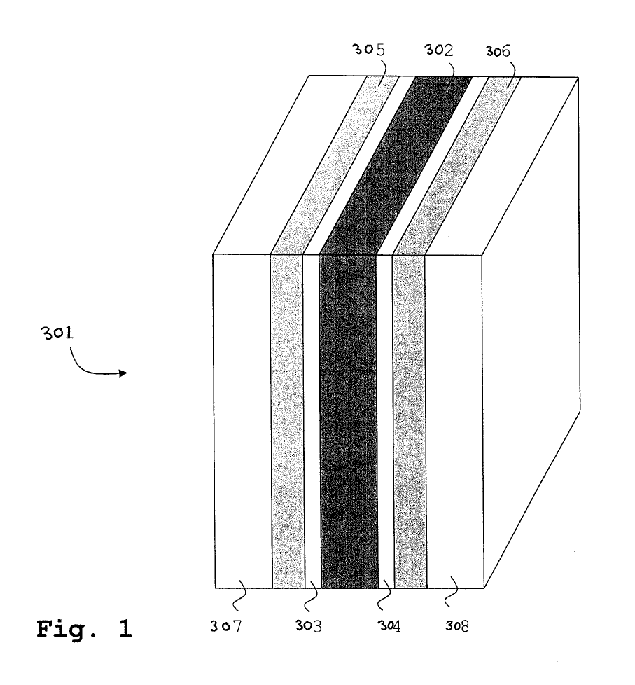

FIG. 1 shows a high differential pressure electrochemical cell for an ionic hydrogen gas compressor;

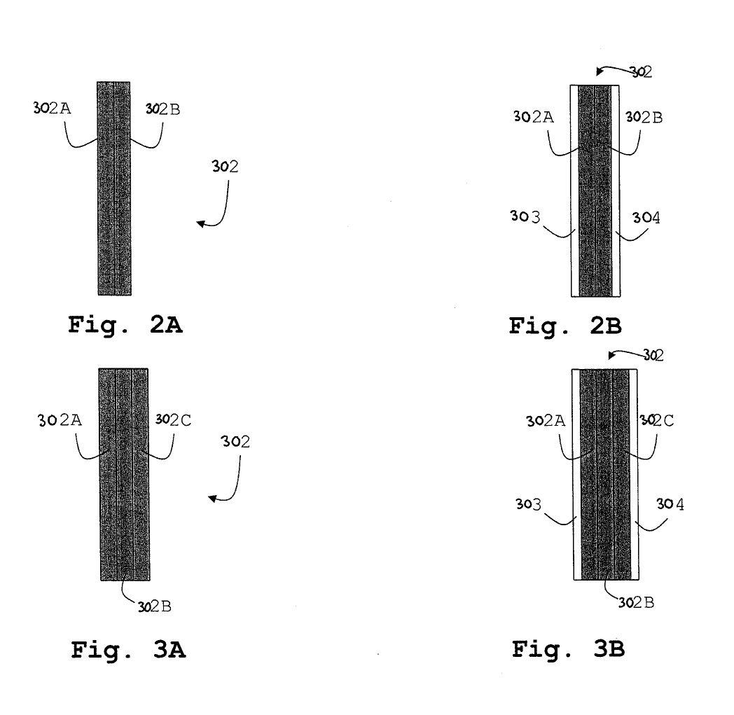

FIGS. 2A and 2B respectively show an ion-conductive membrane and a membrane electrode according to a first embodiment of the invention;

FIGS. 3A and 3B respectively show an ion-conductive membrane and a membrane electrode according to a second embodiment of the invention; and

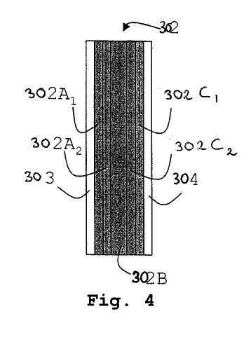

FIG. 4 shows a membrane electrode assembly according to a further embodiment of the invention.

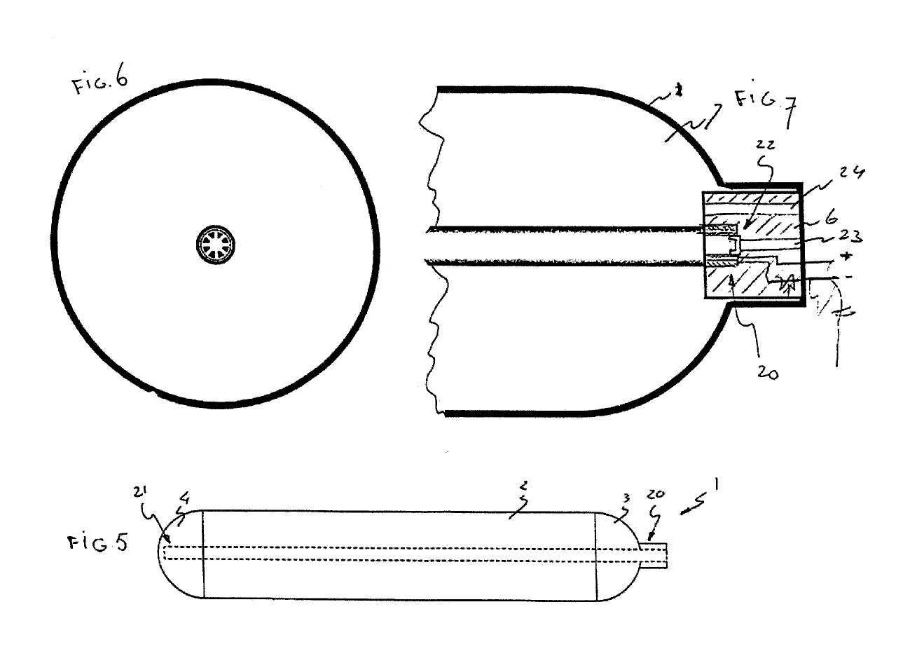

FIG. 5 shows an ionic decompression cell according to the present invention;

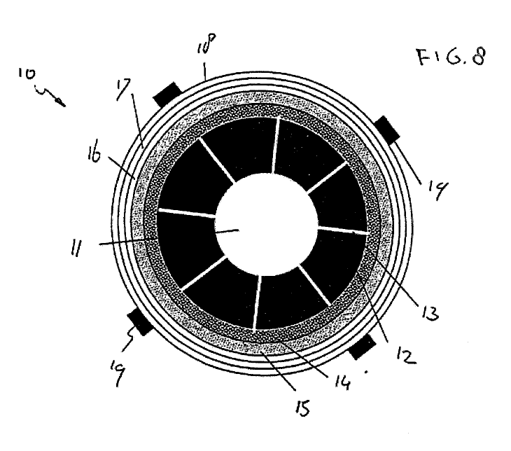

FIG. 6 shows a cross section of the apparatus of FIG. 5;

FIG. 7 shows in part a longitudinal cross section of the apparatus of FIG. 5;

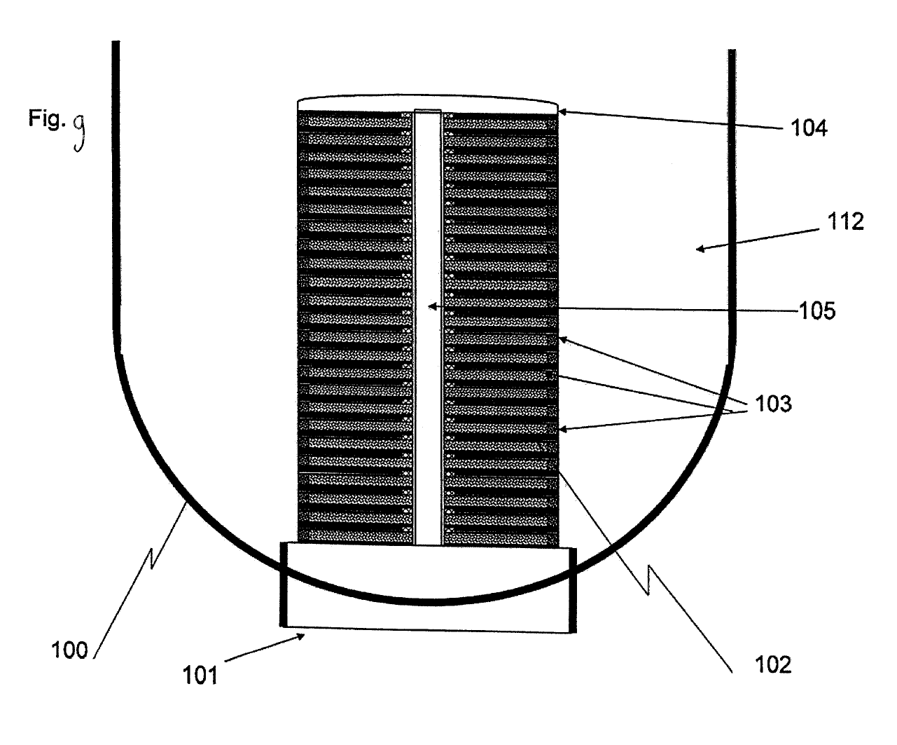

FIG. 8 shows a cross section of the membrane electrode assembly and low pressure chamber of the ionic decompression cell in FIG. 5;

FIG. 9 shows in schematic longitudinal cross section a second embodiment of a high pressure vessel according to the present invention;

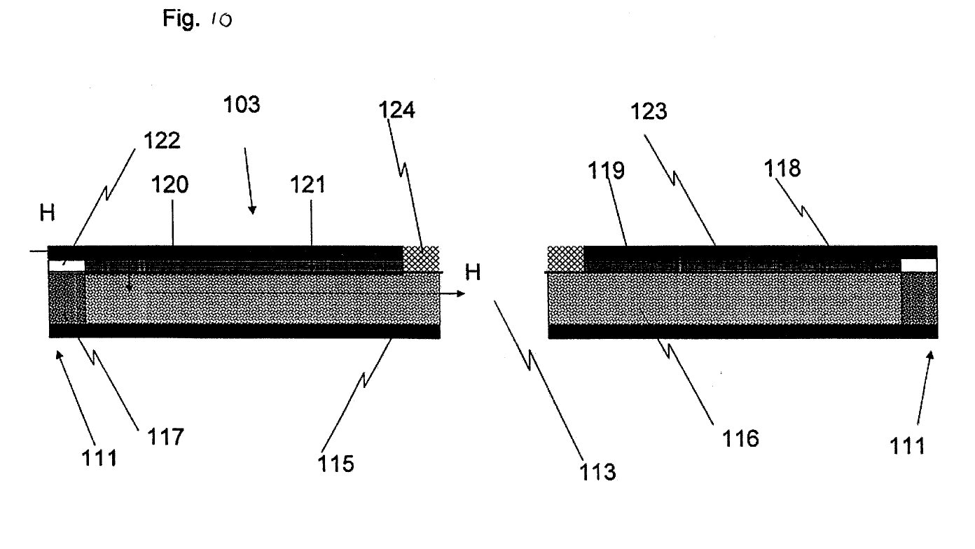

FIG. 10 shows in schematic cross section a cell of a stack of the vessel of FIG. 9;

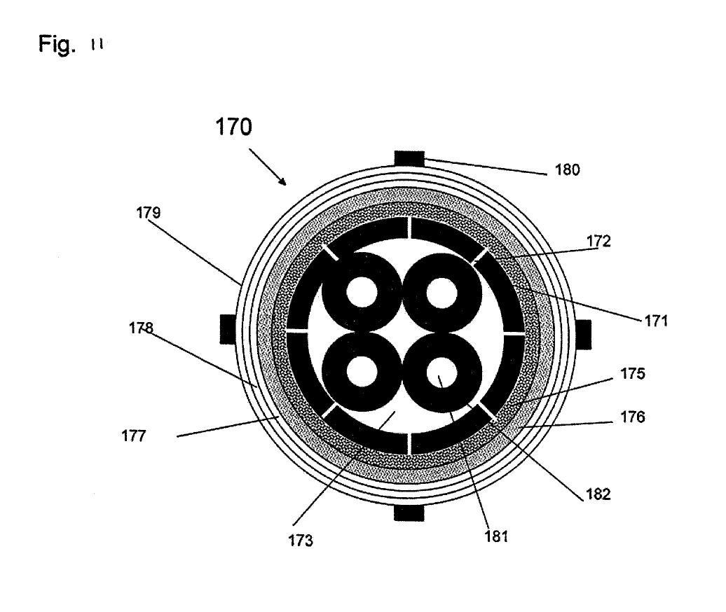

FIG. 11 shows in cross section a cooling system for an ionic decompression cell according to the invention;

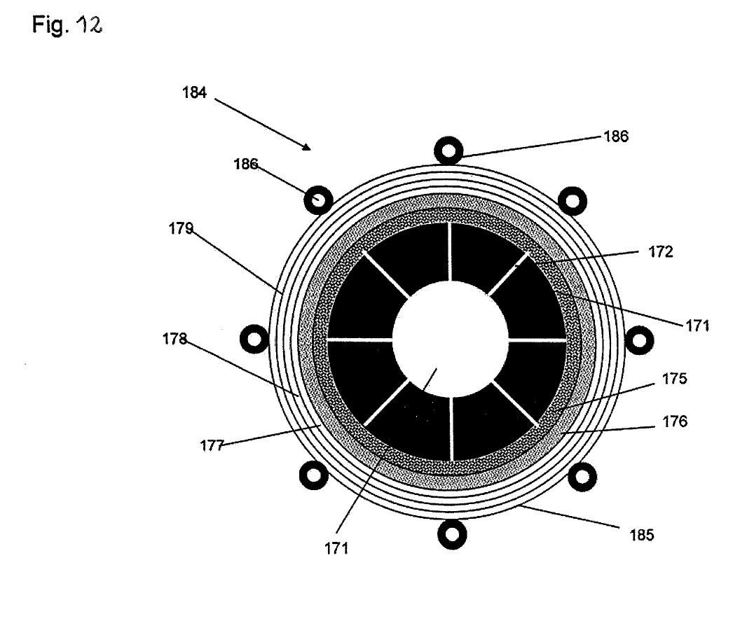

FIG. 12 shows in cross section an alternative cooling system for an ionic decompression cell according to the invention;

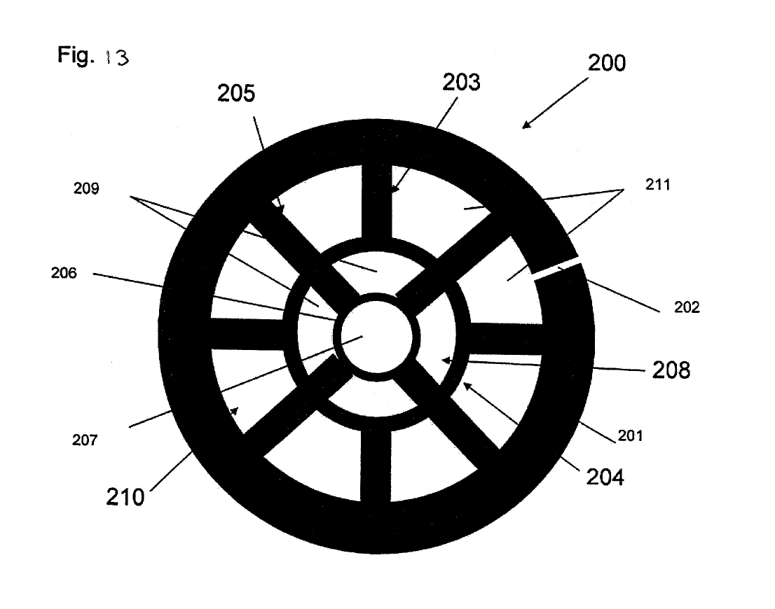

FIG. 13 shows in cross section an alternative configuration of cooling channels for an ionic decompression cell according to the invention;

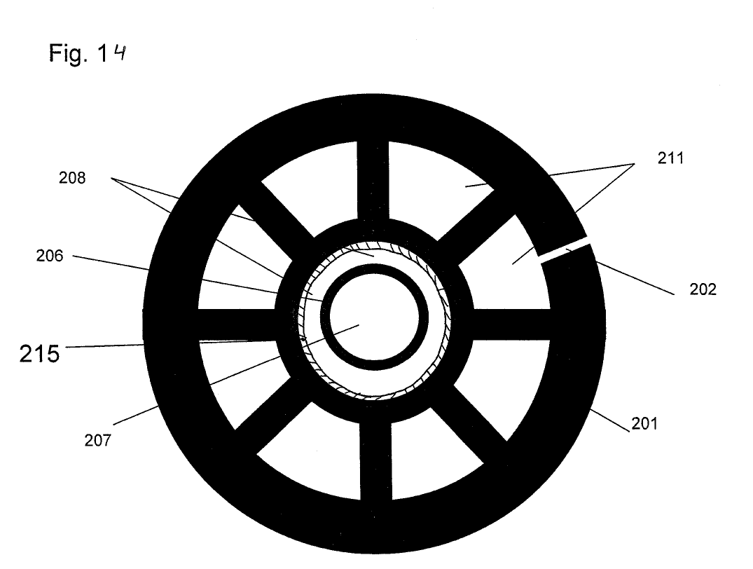

FIG. 14 shows in cross section an further alternative configuration of cooling channels for an ionic decompression cell according to the invention.

In the present invention use is made of an ion-conductive membrane comprising at least two ion-conductive layers, wherein at least one of said ion-conductive layers is electrically insulating and at least one of said ion-conductive layers is electrically conductive. In the context of the present invention the layer which is electrically insulating is insulating in the direction perpendicular to the membrane plane.

The membrane as a whole is ion-conductive, in particular proton-conductive, and electrically insulating.

It has appeared that the combination of an electrically insulating layer and an electrically conductive layer provides a membrane which, when the membrane is in use, has a decreased permeability for molecular oxygen and molecular hydrogen, without affecting the permeability for protons. This result in increased performance of high differential pressure electrochemical cells, for example ionic gas compressors, ionic gas decompressors and high pressure electrolysers. It may also result in improved durability of the system due to increased resistance of the membrane to mechanical stress because the electrically conductive filler material, for example Carbon Nano Tubes, acts as a reinforcement to the membrane.

The ion-conductive membrane comprises at least two ion-conductive layers, wherein at least one of said ion-conductive layers is electrically insulating and at least one of said ion-conductive layers is electrically conductive.

The membrane used in the present invention has a decreased permeability for molecular gases, e.g., for molecular oxygen and molecular hydrogen. Without wishing to be bound by theory it is believed that this is caused by the following mechanism. Where an ion-conductive layer is present at the surface of the membrane which is in contact with molecular hydrogen, for example on the surface of the membrane in the hydrogen chamber of an electrolyser, molecular hydrogen may start to permeate through the membrane. In the ion-conductive layer, hydrogen reacts to form protons and electrons. The protons are transported through the ion-conductive membrane. The electrons are transported through the conductive layer back to an electrode. Consequently, the local hydrogen concentration in the electrically conductive layer is considerably reduced at particular locations by these reactions. These locations constitute drains for further molecular hydrogen that may react as well.

In the same way the membrane according to the invention is a barrier for molecular oxygen. Molecular oxygen that dissolves in the membrane, and diffuses to the hydrogen side can react in the membrane with protons at the catalytic sites present because the membrane is proton conducting and electron conducting. This is of particular importance for electrochemical cells wherein one of the chambers contains oxygen, e.g., in the case of an high pressure electrolyser.

When the apparatus is in use, this results, in short, in intercepting molecular hydrogen and molecular oxygen that is permeating through the membrane and causing it to contribute to the efficiency of the apparatus. The electrically conductive layer acts as a barrier against transfer of molecular hydrogen and oxygen through the membrane.

Within the context of the present specification, an ion-conductive layer is a layer with an ion conductivity in particular a proton conductivity, of at least 0.01 S/cm, at 65° C. and 100% RH. An electrically insulating layer is a layer with an electric break down strength of at least 10 kV/mm. An electrically conductive layer is a layer with an electric breakdown strength of less than 10 kV/mm. As will be evident to the skilled person, the electrically insulating layer should be such that, under conditions of use in electrochemical cells of the preferred embodiment, no breakdown occurs, and the electric current leak through the electrically insulating layer is less than 5%, typically less than 1% of the average current during operation. The typical current density in the high differential pressure electrochemical cells of the preferred embodiments is in the range of 5.000 to 20.000 A/m². The maximum electric current through the electrically insulating layer generally is 1000 A/m², more in particular 500 A/m², still more in particular 100 A/m².

Materials suitable for manufacturing ion-conductive electrically insulating membranes are known in the art, and may be inorganic or organic in nature, with organic materials generally being plastics. Suitable membranes encompass ceramic membranes, such as perovskite membranes like for example KH(PO₃H)—SiO₂ composites. Suitable plastic membranes encompass sulphonated polystyrene, sulphonated polyphenylene ethers, for example sulphonated polyphenyl ethers, or PPEs, and polyphenylene oxides, or PPOs. Copolymers of ethenesulfonic acid, for example with styrene, vinyl chloride, and ethene may also be used, as may be sulphated polymers (sulphate esters) of for example, polyvinyl alcohol, or more in general sulphated hydroxy-functional polymers, sulphonated aromatic polyamides and polyimides, and, more in general, sulphonic acid functional condensation polymers. Further suitable polymers include complexes of basic polymers with strong acids, for example, polyvinyl pyridine, polyethyleenimine, polyimidazoles, including polyvinylimidazole, and diallylammonium-polymers. When used in the presence of water, examples of suitable polymers include fluorinated sulfonic acid polymer (PFSA), sulfonated polyethersulfone (SPES) polymers, sulfonated poly(ether ether ketone) (SPEEK) polymer, sulphonated polyether keton (SPEK), sulfonated poly(ether ketone ketone) (SPEKK), and sulfonated poly(arylene ether sulfone) (SPSU).

If so desired, the electrically insulating layer contains spacer particles, that is, particles which help to ensure that the layer has a predetermined thickness. This is important because while the electrically insulating layer may be quite thin, for example in the region of 0.1-10 microns. It should not contain sections which are too thin, as this will affect the breakdown strength of the layer. The use of spacer particles, of a size of, between 0.1 and 10 microns, will ensure that the electrically insulating layer is locally not thinner than the stipulated value. Fibrous spacer particles are preferred because they also add to the mechanical properties of the membrane.

To improve properties like mechanical strength and durability, the membrane may be reinforced with fibres, e.g., glass fibre (non) wovens, PTFE fibre (non) wovens, porous films or layers, e.g., of polymer like Solupor, or reinforcing particles, such as silica. If so desired the reinforcing material or spacer material, if used, may be pretreated to ensure improved, compatibility with the membrane layers.

The invention pertains to a high differential pressure electrochemical cell. Within the context of the present specification, a high differential pressure electrochemical cell has a pressure difference between the high pressure chamber and the low pressure chamber in use of the electrochemical cell of at least 1 MPa. In one embodiment, the pressure differential in use is at least 10 MPa, more in particular at least 20 Mpa, still more in particular at least 40 MPa. In one embodiment, the increased pressure differential is at least 60 Mpa. The upper limit for the pressure is not critical. A value of 200 MPa may be mentioned. A preferred range of 60-90 MPa may be mentioned.

In order to withstand the pressure differences between the high-pressure chamber and the low-pressure chamber, in a preferred embodiment of the invention a support structure may be provided. This can, for example, be in the form of a porous support structure at the low pressure side of the membrane. The support structure should be able to withstand the pressure difference between the low pressure side of the membrane and the high pressure side of the membrane. This pressure difference can for compressors/decompressors be as high as 200 MPa, but is more typically 80 MPa. In general, the pressure difference between one side of the membrane and the other is at least 1 MPa, in particular in the range of 1-200 MPa, more in particular in the range of 60-90 MPa. The present invention also pertains to a membrane electrode assembly of this structure.

In one embodiment, the porous support structure is a layered structure, adjacent to the membrane in the low-pressure chamber, which comprises, starting from the electrode side, a porous permeable layer with pores of less than 1 micron, a porous permeable layer with pores with a diameter in the range of 1-100 microns, and a solid mechanically rigid layer. Depending on the configuration of the apparatus, the solid mechanically rigid layer may be non-porous and impermeable to the reactants. In this embodiment, the reactants will be transported through the porous layer to the side of the material. This structure can for example be obtained as follows: In a first step a macroporous layer is provided with high gas permeability and sufficient mechanical strength. Suitable materials are for example sintered metal powders like bronze, copper, nickel, stainless steel, titanium, or aluminum. On top of this macro-porous layer a micro porous layer is provided having sufficient mechanical strength and sufficient gas permeability in the direction perpendicular to the surface. The pores in the micro-porous layer are typically <1 micron. On top of this micro porous support layer a porous electrode layer is applied. This porous electrode layer contains a suitable catalyst, is proton conductive, and electroconductive. A suitable material is a micro porous palladium layer or a layer of a palladium alloy, such as a palladium rhodium alloy. The thickness of this cathode layer is typically a few microns.

The permeability for molecular gases, in particular molecular hydrogen and oxygen, of the various layers of the membrane should be as low as possible. In general this will mean that the membrane layers will be non-porous. Should pores be present in one or more membrane layers, the pore structure should be such that the permeability for molecular gases is not substantially affected. This will generally mean that the pore structure is discontinuous, and that any pores have a diameter which is significantly smaller than the thickness of the membrane layer.

In one embodiment, the ion-conductive and electrically conducting layer of the membrane comprises an ion-conductive matrix with an electrically conductive filler dispersed therein. The ion-conductive matrix is for example a polymer matrix. Suitable polymers are those discussed above for the insulating layer.

The electrically conductive filler comprises a particulate conductive material, such as carbon. In the present specification the word particulate also encompasses the use of fibrous materials. The amount of filler should be selected such that the filler forms a conductive network of particles within the polymer matrix. If the amount of filler is too low, a network of particles will not be formed and the electrical conductivity of the layer is detrimentally affected. On the other hand, if the amount of filler is too high, the amount of ion-conductive matrix is too low, and the ion conductivity of the layer is affected. Further, if the amount of filler is too high, the amount of matrix may become so low that it becomes difficult to obtain a continuous membrane layer. This may lead to an increased permeability for molecular hydrogen. The appropriate amount of filler depends on the nature of the matrix, on the conductivity of the filler, and also on its particle size and shape. Suitable fillers include carbon materials such as carbon nanotubes and carbon particles. As an example of a suitable carbon material. KetjenBlack EC 600 of Akzo Nobel, or Vulcan of Cabot may be mentioned. It is within the scope of the skilled person to prepare ion-conductive electrically conductive layers on the basis of the above.

The reaction in the ion-conductive electrically conductive layer from molecular hydrogen into protons and electrons, and of molecular oxygen and protons into water is catalysed by catalytically active sites present in the layer. These sites may form automatically, e.g., by migration of some catalyst, such as platinum, from the electrodes into the electrically conductive layer. However, they may also be formed on purpose, by incorporating a catalytically active material into the membrane during manufacture. In one embodiment this can be done by applying a catalytically active material, for example platinum onto the filler material.

In one embodiment of the present invention the concentration of catalytic sites in the electrically conductive layer is inhomogeneous over the cross-section of the layer, with the concentration being lower at the electrode-side of the layer and higher at the side of the layer which is adjacent to the electrically insulating layer. In this embodiment the reaction of the molecular hydrogen to form protons take place further away from the electrode. This reduces the formation of a driving force for molecular gas into the membrane. In one embodiment, the electrically conductive layer is built up from two or more layers, wherein the outer layer, that is, the layer on the electrode side of the membrane has a content of catalytically active material which is lower than that of the layer(s) further removed from the surface, with the content of catalytical material increasing with increasing distance from the electrode.

In one other embodiment of the present invention the concentration of catalytic sites in the electrically conductive layer is also inhomogeneous over the cross-section of the layer, with the concentration being higher at the electrode-side of the layer and lower at the side of the layer which is adjacent to the electrically insulating layer. In this embodiment the reaction of the molecular hydrogen to form protons, and molecular oxygen and protons to form water take place closer to the electrodes. In this embodiment, the electrically conductive layer is built up from two or more layers, wherein the outer layer, that is, the layer on the electrode side of the membrane has a content of catalytically active material which is higher than that of the layer(s) further removed from the surface, with the content of catalyti material decreasing with increasing distance from the electrode.

The total membrane generally has a thickness of 25 to 1000 microns, more in particular of 50 to 500 microns. The conductive layers generally make up between 1 and 99% of the total thickness of the membrane. More specifically, it may be preferred for the electrically conductive layers to make up a substantial part of the membrane. The electrically insulating layer may be relatively thin, as long as dielectric breakdown strength is higher than the maximum cell voltage. Accordingly, in one embodiment the conductive layers make up between 30 and 90% of the total thickness of the membrane, more in particular between 50 and 80%.

Where an electrically conductive layer is present at the surface of a membrane which is in contact with molecular oxygen, e.g., the surface of a membrane present in the water chamber of an electrolyser, the electrically conductive layer helps to reduce the formation of peroxide and oxygen radicals. The formation of these compounds are known to reduce the service life of membranes as they are used high differential, pressure electrochemical cells.

In this embodiment, the electrically conductive membrane layer contributes to preventing molecular oxygen from diffusing from the anode side towards the cathode side of the high differential pressure electrochemical cell according to the invention, in particular an high pressure electrolyser by the reaction O₂+4H⁺+4e⁻→2H₂O. In a particularly advantageous embodiment of the invention, the membrane according to the invention comprises an electrically insulating, ion-conductive layer interposed between a first electrically conductive ion-conductive layer and a second electrically conductive ion-conductive layer.

In use in an high pressure electrolyser, the first electrically conductive ion-conductive layer acts as an effective barrier against transfer of molecular hydrogen from the hydrogen forming electrode (cathode) towards the oxygen forming electrode (anode), whereas the second electrically conductive ion-conductive layer acts as a barrier against transfer of molecular oxygen from the oxygen forming electrode (anode) towards the hydrogen forming electrode (cathode).

Again, the presence of catalytically active positions in the second electrically conductive ion-conductive layer of the membrane assists the reaction, and in one embodiment of the invention these sites are present in this layer. For particulars on the nature of the electrically conductive ion-conductive layer, reference is made to what has been stated above. Again, it may be preferred for the concentration of catalytically active material to be non-uniform over the thickness of the membrane.

In one embodiment of the present invention a membrane is used which comprises, starting from the side of the anode, a first electrically conductive, ion-conductive layer, a second electrically conductive, ion-conductive layer with a concentration of catalytically active material which is higher than the concentration of catalytically active material in the first electrically conductive, ion-conductive layer, an electrically insulating ion-conductive layer, a third electrically conductive, ion-conductive layer, and a fourth electrically conductive, ion-conductive layer, which has a concentration of catalytically active material which is lower than the concentration of catalytically active material in the third electrically conductive, ion-conductive layer.

In one other embodiment of the present invention a membrane is used which comprises, starting from the side of the anode, a first electrically conductive, ion-conductive layer, a second electrically conductive, ion-conductive layer with a concentration of catalytically active material, which is lower than the concentration of catalytically active material in the first electrically conductive, ion-conductive layer, an electrically insulating ion-conductive layer, a third electrically conductive, ion-conductive layer, and a fourth electrically conductive, ion-conductive layer, which has a concentration of catalytically active material which is higher than the concentration of catalytically active material in the third electrically conductive, ion-conductive layer.

In one embodiment, the ion-conductive layer at the anode side of the membrane, viz. the side of the water chamber when used in an high pressure electrolyser, has a loading of catalytically active material which is higher than the concentration of catalytically active material in the electrically conductive layer at the cathode side of the membrane, viz. the side of the hydrogen chamber in an high pressure electrolyser. In general, the concentration of catalytically active material in the layer at the anode side is between 0.01 and 60 wt. %, calculated on the weight of the carbon support on which it is deposited. In general, the concentration of catalytically active material in the layer at the cathode side is between 0.01 and 60 wt. %, calculated on the weight of the carbon support on which it is deposited.

In a further embodiment of the present invention, the ion-conductive electrically insulating layer is profiled, for example in the form of a regular or irregular wave or saw pattern, or in any other non-flat profile. The crux of this embodiment is that the transport of protons through the membrane is improved by ensuring that the direction of the electrical field over the electrically insulating layer is parallel and opposite to the transport direction of the protons over the entire surface of the electrically insulating layer.

In one embodiment of the present invention the membrane comprises two electrically insulating layers, with a conductive layer in between, the conductive layer being provided with a catalytically active material. In this embodiment oxygen which passes though the electrically insulating layer will react in the conductive layer between the insulating layers with hydrogen to form water. While the presence of the conductive layer does not contribute to the efficiency of the electrochemical cell (no current is generated), it does contribute to the removal of oxygen and peroxy radicals, which increases cell life. In this embodiment, the membrane will comprise, sequentially, starting from an electrode, an electrically conductive layer, an electrically insulating layer, an electrically conductive layer, an electrically insulating layer, and, preferably, a further electrically conductive layer. All electrically conductive layers are at least over part of their cross-section catalytically active.

Membranes used according to the invention may be manufactured by methods known in the art for the manufacture of multilayer films. Examples of suitable methods include coextrusion, solution casting, slot dye coating, slide coating etc. For example, a membrane may be manufactured by sequentially casting polymer solutions with appropriate compositions onto a surface, for example a film or a roll, and allowing the solutions to solidify before applying the next solution.

In the high differential pressure electrochemical cell according to the invention, the membrane discussed above will be in the form of a membrane electrode assembly (MEA) comprising a membrane as discussed above which has a first surface that is provided with a first electrode, and a second surface that is provided with a second electrode. In use in an ionic gas compressor, the first electrode positioned in the low pressure chamber will be in contact with ionisable gas, e.g. hydrogen, and will serve as anode. The second electrode positioned in the high pressure chamber will be in contact with the same ionisable gas, e.g. hydrogen, and will serve as cathode. In use in an ionic gas decompressor, the first electrode positioned in the high pressure chamber will be in contact with ionisable gas, e.g. hydrogen, and will serve as anode. The second electrode positioned in the low pressure chamber will be in contact with the same ionisable gas, e.g. hydrogen, and will serve as cathode. In use in an electrolyser, the first electrode will be in contact with water and will serve as anode. The second electrode will be in contact with molecular hydrogen, and will serve as cathode.

The electrodes have an electric conductivity sufficient to have acceptable electric ohmic losses. To this end electrodes may be used with sufficiently high specific conductivity, and sufficient thickness.

Optionally, an electrode can be used comprising an electroconductive catalytic material in combination with an electroconductive catalytically inactive material. The catalytic material will ensure the conversion of reactants into ions and electrons, and the electroconductive material ensures transport of the electrons. In another embodiment, if so desired, the electroconductivity of one or both electrodes can be further improved by providing a highly conductive current distribution material or grid on top of the electrode.

The first electrode is an electrically conductive layer comprising a material which is able to catalyse the conversion of e.g. molecular hydrogen, into protons and electrons. Suitable catalysts are all known ionising catalysts like platinum, palladium and other platinum group metals and alloys thereof. Also non-noble metals and transition metal oxides known to be catalytically active towards the preferred reactions can be used. In one embodiment, the electrode comprises a thin film of palladium or palladium alloy. The first electrode will generally have a thickness in the range of 0.2 to 1.0 microns, more in particular in the range of 1 to 5 microns.

The second electrode is an electrically conductive layer comprising a material which is able to catalyse the reaction of protons with electrons to form molecular hydrogen. Suitable catalysts are known in the art and comprise, for example, platinum, palladium, other platinum group metals, and some palladium alloys, but also many other materials which show catalytic activity in this reaction. Preferably, the second electrode is an electrically conductive layer that is permeable for molecular hydrogen and protons, e.g., by virtue of having a porous structure, e.g. resistant to pressures of 100 MPa or more, e.g., 200 Mpa or more. The second electrode generally will have a thickness in the range of 0.5 to 100 microns, more in particular in the range of 1 to 10 microns, typically in the range of 2-5 microns.

In one embodiment, the proton conductive membranes can for example comprise a hydrogen permeable support layer. The support structure can for example overlay the second electrode, and can comprise—starting from the side of the second electrode—one or more hydrogen permeable layers and a mechanically rigid layer, which is sufficiently rigid to withstand the pressure difference between the high pressure chamber and the low pressure chamber. The support layer should be made of electro conductive and thermally conductive materials with pores enabling hydrogen transmigration.

In one embodiment, the invention pertains to an ionic gas compressor having a membrane consisting of an electrically insulating ionic conductive layer sandwiched between two electrically and ionic conductive layers. In this embodiment, the crossover of molecular hydrogen in de membrane due to the large differential pressure is reduced.

In another embodiment, the invention pertains to an ionic gas decompressor having a membrane consisting of an electrically insulating ionic conductive layer sandwiched between two electrically and ionic conductive layers. In this embodiment, the crossover of molecular hydrogen in de membrane due to the large differential pressure will be reduced.

In another embodiment, the invention pertains to an high pressure electrolyser having an electrically conductive layer on the side of the surface of the membrane in the water chamber and an electrically insulating layer is present on the side of the membrane present in the hydrogen chamber. In this embodiment, the formation of oxygen radicals and peroxides in the water chamber will be reduced. In one embodiment, the electrolyser according to the invention encompasses a water chamber and a hydrogen chamber, said chambers being separated by a membrane, the membrane being ion-conductive, in particular proton-conductive, and electrically insulating, the membrane having a first surface in the water chamber and a second surface in the hydrogen chamber, the first surface being provided with a first electrode, and the second surface being provided with a second electrode, the first and second electrodes being electroconductively connected to each other via an electric circuit, wherein the membrane comprises at least two ion-conductive layers, wherein at least one of said ion-conductive layers is electrically insulating and at least one of said ion-conductive layers is electrically conductive.

In another embodiment, the invention pertains to an electrolyser having an electrically insulating layer present on the side of the surface of the membrane in the hydrogen chamber and an electrically conductive layer is present on the side of the membrane present in the water chamber. In this embodiment, the permeability of the membrane for molecular hydrogen will be reduced.

In a further embodiment, an electrically conductive layer is present on the side of the surface of the membrane in the cathode flow field and an electrically conductive layer is present on the side of the membrane present in the anode flow field, with an insulating layer being interposed between the two electrically conductive layers. In this embodiment both the formation of oxygen radicals and peroxides in the water chamber and the permeability of the membrane for molecular hydrogen will be reduced.

The invention also pertains to a process for compressing hydrogen wherein a hydrogen-containing gas is fed to the low pressure chamber of the ionic gas compressor and an electric current is provided to the electric circuit of said ionic gas compressor, and hydrogen is pumped into the high pressure chamber of the ionic gas compressor.

The invention also pertains to a process for decompressing hydrogen wherein a hydrogen-containing gas stored at high pressure is fed to the high pressure chamber of the ionic gas decompressor and an electric current is drawn from the electric circuit of said ionic gas decompressor, and hydrogen is decompressed into the low pressure chamber of the ionic gas decompressor.

The invention also pertains to a process for converting water into hydrogen and oxygen wherein water is fed to the water chamber of the electrolyser of the present invention and an electric current is provided to the electric circuit of said electrolyser, and oxygen is withdrawn from the water chamber and hydrogen is withdrawn from the hydrogen chamber of the electrolyser.

The high differential pressure electrochemical cell according to the invention, in particular the ion pump or ionic decompressor, can be operated with hydrogen-containing gas. Hydrogen-containing gas comprises at least 5 mol. % of molecular hydrogen. In one embodiment, hydrogen is used (which, for the purposes of the present invention is hydrogen gas which contains at least 95 mol. % of hydrogen, in particular at least 98 mol. %). In the present specification the invention will be explained with reference to hydrogen, but it will be clear to the skilled person where the use of hydrogen-containing gas which additionally contains other components may be envisaged. In some embodiments, the use of hydrogen-containing gas which contains at least 50 mol. % of hydrogen, more in particular at least 70 mol. %, still more in particular at least 80 mol. %, even more in particular at least 90 mol. % may be preferred.

In one embodiment, the present invention is directed to an high differential pressure electrochemical cell which is an ionic gas compressor or an ionic gas decompressor, which comprises a plurality of chambers including at least one high-pressure chamber and at least one low-pressure chamber separated from at least one of the high-pressure chambers by an ion-conductive membrane, wherein at least one of the chambers is bordered by the ion-conductive membrane at two opposite sides of the chamber, wherein each of the ion conductive membranes has a first surface in one of the high pressure chambers and a second surface in one of the low pressure chambers, the first surface being provided with a first electrode, and the second surface being provided with a second electrode, the first and second electrodes being electroconductively connected via an external electric circuitry. In this context, the word external means that the electric circuitry does not run through the membrane itself.

The proton conductive membranes can for example fully enclose one of the high pressure or low pressure chambers. To this end, the proton conductive membrane can for example be tubular.

The low pressure chambers can for example be integrally arranged within a high pressure chamber, such as a high pressure storage vessel or tank. Such a storage tank, which is preferably cylindrical, can have an opening at one or on both ends, closed by a connector block for connection of the tank to a high pressure hydrogen supply line and/or a hydrogen gas discharge line and electrical contacts for connecting electric circuitry. One or both of these adaptors can be connected to one or more tubular ionic decompression cell, comprising a high pressure tube, able to resist the pressure difference between a central high pressure chamber and a coaxial low pressure chamber. Such an embodiment of the apparatus according to the invention may be provided with a coaxial heat exchange channel, and/or an inner heat exchange tube, preferably of a polymer material, which can be used for cooling and/or heating. The tubular ionic decompression cell can, e.g., be connected to an end adaptor by welding or soldering or by mechanical connection in combination with high pressure gaskets. Pressure changes and temperature changes of the tubular apparatus as well as temperature of the high pressure tank, will result in length changes during operation. This problem can for example be solved by fixing the tubular ionic decompression cell only on one side, and providing a sliding fixture on the other side. Optionally, the connector block can be provided with additional features such as a high pressure inlet, a pressure reducer, an excess flow valve, a needle valve, pressure and/or temperature sensors, an overpressure relief valve, a low pressure outlet, DC contacts, grounding and/or power and control electronics.

Alternatively, the pressure chamber can comprise a stack of proton conductive membranes each membrane being sandwiched between a surface cathode and an surface anode, wherein a first porous layer overlays the surface anode and is in open communication with the high pressure chamber and sealed against the low pressure chamber whereas the surface cathode is covered by a second porous layer which is in open communication with the low pressure chamber and sealed against the high pressure chamber. The first porous layer on a first membrane in the stack is separated from the second porous layer of a second membrane above the first membrane by an electro conductive layer, which is impermeable for hydrogen (H₂). This way, a series connection is obtained wherein electrons from the anode of a membrane electrode assembly can migrate to the cathode of a higher stacked membrane electrode assembly to recombine with protons conducted by the higher stacked membrane. The top membrane electrode assembly can be connected with the lowest membrane electrode assembly via an external electric circuit.

The surface anode can partly penetrate the porous structure. This results in a roughly structured anode with increased surface area. It has been found that this improves the pressure resistance of the anode. Similarly, the cathode can partly penetrate the adjacent porous structure, which similarly results in improved pressure resistance of the cathode.

Alternatively, one or more of the low pressure chambers can be sandwiched between two high pressure chambers. Parallel proton conductive membranes, can be used to border the sandwiched low and/or high pressure chamber. The parallel membranes can for example be flat membranes. In one embodiment, the low-pressure chamber is a flat porous plate, with on both sides a membrane electrode assembly and a high pressure chamber. Because of the symmetry the high pressure on one side is countered by the same high pressure on the other side.

Where the high differential pressure electrochemical cell is a ionic gas decompressor, in operation, the high pressure chamber can be filled with pressurized hydrogen, generally at a pressure of at least 0.6 MPa, in particular between 0.6 and 200 MPa, more in particular between 1 and 100 MPa, still more in particular between 20 and 90 MPa, or between 60 and 90 MPa, while the low-pressure chamber may for example comprise hydrogen at a pressure which is lower than the pressure in the high-pressure chamber, in particular below 1 MPa, more in particular between 0.15 and 0.6 MPa. Pressures can be measured by known instruments connected to the chamber.

The invention will be further illustrated with reference to the attached drawings, which schematically show preferred embodiments according to the invention. It will be understood that the invention is not in any way restricted to these specific and preferred embodiments.

In FIG. 1, a high differential pressure electro-chemical cell for an ionic hydrogen gas compressor 301 comprises a central polymer electrolyte membrane 302 with two primary surfaces, two separate electrode catalyst layers 303, 304, e.g. suitable hydrogen oxidation reaction (HOR) catalyst such as platinum on the anode side and a suitable hydrogen reduction reaction (HRR) catalyst such as platinum at the cathode side, each with an inner layer attached to one of the two primary surfaces, respectively referred to as the anode and cathode. Two microporous support layers 305, 306, for example a sintered metal layer with high gas permeability and sufficient mechanical strength, are attached to the outer surfaces of the electrode catalyst layers 303, 304. The electrodes 303, 304, are present, respectively, in the low pressure chamber 307 and the high pressure chamber 308.

The low pressure chamber 307 has an inlet for gaseous hydrogen gas (not shown). The high pressure chamber has an outlet for gaseous hydrogen (not shown).

The polymer electrolyte membrane 302, the anode catalyst layer 303 and the cathode catalyst layer 304 together constitute a membrane electrode assembly (MEA).

In an embodiment of the invention, the membrane 302 comprises at least two ion-conductive layers 302A and 3023. The ion-conductive layer 302A is electrically conductive, whereas the other layer 302B electrically insulating. FIGS. 302A and 302B respectively show such a membrane 302 and a MEA comprising this multi-layer membrane disposed between the anode catalyst layer 303 and the cathode catalyst layer 304. Preferably, both membrane layers are substantially impermeable to the molecular hydrogen fuel gas and, where present, the oxygen gas.

In a further embodiment of the invention, a membrane 302 is provided comprising an electrically insulating, ion-conductive layer 302B interposed between a first electrically conductive ion-conductive layer 302A and a second electrically conductive ion-conductive layer 302C. Such a membrane 302 and a membrane electrode assembly comprising such a membrane are shown in FIGS. 3A and 33. The composition of the first and second electrically conductive ion-conductive layers 302A, 302C may be the same of different.

In FIG. 4, the electrically conductive layers 302A, 302C are made up of electrically conductive sublayers 302A1, 302A2 and 302C1, 302C2 respectively. The concentration of catalytically active material in the outer layers 302A1 and 302C1 is lower than the concentration of catalytically active material in the inner layers 302A2 and 302C2.

Various embodiments of ionic compressors/decompressors will be discussed with reference to FIGS. 5-14 below.

FIG. 5 shows an ionic decompression cell according to the invention comprising a high pressure hydrogen tank 1, e.g., for a fuel cell of an automotive vehicle. Typically, such a hydrogen pressure tank has a length of about 2 meters and a diameter of about 0.4-0.5 meter. The tank 1 comprises a cylindrical body 2 capped with semi-spherical end sections 3, 4. One of the end sections 3 comprises an opening 5 plugged with a connector block 6 with provision for various connections, as will be explained hereinafter. The interior of tank 1 forms high pressure chamber 7 containing pressurized hydrogen H₂.

Within the tank 1 a membrane tube 10 extends from one end section 4 to the opposite end section 3 in coaxial arrangement with the cylindrical body 2. The outer diameter of the membrane tube is about 20 mm. As shown in more detail in FIG. 4, the decompression tube comprises a central low pressure chamber 11 surrounded by a mechanically rigid pressure resistant tubular wall 12, which is resistant to at least the pressure difference between the pressure in the low pressure chamber 11 and the pressure in the pressure tank 1. The tubular wall 12 can for example be made of a stainless steel, such as Steel grade 316. The tubular wall 12 is provided with radially extending apertures 13. On its outer surface the tubular wall 12 is coated with a macroporous support layer 14 with pores of more than 1 micron. This support layer can be a metal coating, e.g., applied by slurry dipping and sintering, and can for example have an average layer thickness of about 1 mm. Applied on top of this macroporous support layer 14 is a sintered microporous support layer 15 of a metal coating with pores of less than 1 micron. On top of this microporous support layer a Group VIII metal cathode layer 16 is applied, e.g., by means of vacuum sputtering. During the sputtering process the tube is rotated to get a uniform coating thickness. This porous cathode layer 16 contains a suitable catalyst and is conductive for protons as well as for electrons. To this end, the cathode layer 16 can for example be a platinum, palladium or palladium alloy layer. The thickness of this cathode layer is about 1-3 microns. On top of the cathode layer is a non-porous proton conductive, electrically insulating membrane layer 17, e.g. made of a ceramic or polymeric material, with an average layer thickness in the range of 100-10000 micron. On top of this electrolyte membrane 17, an anode layer 18 is sputtered with a thickness of about 2 micron. The anode layer can for example be made of palladium or a palladium alloy. A copper grid 19 is applied on the anode layer 18, e.g., in an electro-less copper plating bath.

The outer ends 20, 21 of the membrane tube 10 are closed off by end walls. The outer end 20 is held in the connection block 6. The end wall 22 at this outer end comprises a discharge opening operatively connected to a discharge line for discharging depressurized hydrogen gas from the low pressure chamber 11 to, for instance, a fuel cell of an automotive vehicle via an opening 23 in the connector block. The discharge line can be shut with a valve (not shown). The connector block 6 further comprises an inlet opening 24 for connection to a high pressure hydrogen supply line, and provides electrical contacts 25 for respectively connecting the anode and cathode layer 16, 18 to electric circuitry. Optionally, the connection block 6 can also provide one or more sensors, such as pressure sensors and/or temperature sensors, valves, such as excess flow valves, pressure release valves (PRD), and/or needle valves, flow restrictors, cooling fins to control the gas temperature in the high pressure chamber, and power and control electronics.

Due to pressure changes and temperature changes of the length of the membrane tube 10 can change over time relative to the length of the high pressure tank 1. To compensate this, the outer end of the membrane tube 10 opposite the outer end connected to the connection block 6 is supported by a sliding fixture (not shown).

In the embodiment of FIGS. 5-8, the high pressure tank 1 comprises only one membrane tube 10. In other embodiments, two or more membrane tubes 10 can be used, e.g., in a parallel arrangement. For instance, one central decompression tube 10 can be arranged coaxially within the high pressure tank 1, surrounded by five or six equidistantly arranged decompression tubes 10, which may for example be of the same diameter.

FIG. 9 shows a high pressure vessel 100 according to the present invention. The vessel 100 is filled with pressurized hydrogen gas under a pressure of, for instance, 800 MPa. The vessel 100 comprises an outlet 101 plugged with a stack 102 of ionic decompression cells 103. On top of the stack 102 is a cover plate 104. The cover plate 104 can be fixated within the pressure vessel 100, e.g., by means of tie rods or tension members or the like (not shown). Centrally arranged within the stack 102 and coaxially with the vessel 100 is a tubular low pressure chamber 105.

FIG. 10 shows one of the ionic decompression cells 103 in more detailed cross section with arrows indicating the flow of hydrogen as H2 and as protons, respectively. Each cell 103 has an outer circumference 111 facing the high pressure vessel interior 112, and an inner opening 113 forming an axial segment of the low pressure chamber 105. The cell 103 comprises an aluminium foil base layer 115, extending from the opening 113 to the circumference 111. On top of the base layer 115 is a layer 116 of porous aluminium extending from the opening 113 to a point, at short distance from the outer circumference 111 where it is capped by a sealing segment 117 of aluminium which seals the porous layer 116 from the high pressure vessel interior 112. On top of the porous layer 116 is a membrane electrode assembly 118 comprising a proton conductive membrane 119 of about 25 μm sandwiched between an anode surface 120 and a cathode surface 121, both having a thickness of about 1 μm. In line with the membrane electrode assembly 118 and on top of the sealing segment 117 is a sealing strip 122 to seal the membrane electrode assembly from the pressure vessel interior 112. On top of the membrane electrode assembly 118 and the sealing strip 122 is a porous layer 123 of a copper alloy. The membrane electrode assembly 118 and the porous copper alloy layer 123 are sealed from the central opening 113 by a high pressure gasket 124. The gasket 124 and the copper alloy layer 123 show some degree of compressibility to compensate for pressure changes. The aluminium foil base layer 115 comprises collar 125 around the opening 113. The collar 115 has an outer diameter forming a tight fit with the inner diameter of the gasket 124.

The hydrogen flow through the cell 103 is indicated by arrows H. From the high pressure vessel interior, where the pressure can be as high as about 80 MPa, hydrogen gas flows into the porous copper alloy layer 123, where it contacts the anode surface 120. At the anode surface, the hydrogen gas is decomposed as described above into electrons and protons. The protons pass through the proton conductive membrane 119 to the cathode surface 121, where they recombine to H₂ hydrogen gas with electrons coming from the anode layer of a lower cell 103. The recombined hydrogen gas migrates through the porous layer 116 to the opening 113, where a hydrogen discharge channel is defined, as described hereinafter with reference to FIG. 10. An external electric circuit (not shown) connects the surface anode of the upper cell 103 of the stack 102 to the surface cathode of the lowest cell 103. This way, electric current is generated through the electric circuit which may for example comprise a DC/DC converter or other type of electric load.

FIG. 11 shows schematically in cross section a tubular ionic decompression cell 170 for use in a high pressure vessel. The ionic decompression cell 170 comprises a high pressure resistant cylindrical channel wall 171 provided with apertures or perforations 172 for the passage of decompressed hydrogen gas to a low pressure chamber 173 confined by channel wall 171. The channel wall 171 is coated with a macroporous layer 175, which is in turn coated with a micro-porous layer 176, both concentric layers being permeable for hydrogen gas. The microporous layer 176 is coated with an cathode layer 177, which is coated with a non-porous proton conductive and electro insulating membrane 179, which is in turn coated with a porous anode layer 179. A current collecting grid 180 is applied on the outside of the anode layer 179. Four coolant channels 181 are arranged within the low pressure chamber 173, defined by tubular channel walls 182 to provide effective temperature control and to optimize the decompression process.

Alternatively, or additionally, heat exchange channels can be arranged on the outer surface of the decompressor, as for example is shown in FIG. 12, where the same reference numbers are used as in FIG. 11 for parts which are the same in both embodiments. In this case, the cathode layer 179 of the decompressor cell 184 is coated with a current collection layer 185. Heat exchange channels 186 are arranged on the high pressure side of the ionic decompressor cell 184 in order to keep the pressurized hydrogen in the high pressure chamber at a desirable temperature.

FIGS. 13 and 14 show extruded profiles which can be used in an ionic decompression cell according to the invention, for example as shown in FIG. 5. In use, the profiles are surrounded by membrane electrode assemblies or by a stack of such assemblies (not shown). In FIG. 13, the extruded profile 900 is a tubular profile resistant to high pressures and made of an aluminium alloy. The tubular profile 200 comprises an outer cylinder 201 provided with a plurality of drilled holes or apertures 202 (only one being shown in the drawing). Four orthogonally arranged spacers 203 extend inwardly to hold an inner tubular channel wall 204 in coaxial arrangement with respect to the outer cylinder 201. Four larger inwardly extending spacers 205 hold a smaller tube 206 of a material of low thermal conductivity, e.g., a polymeric material. Each spacer 205 is arranged between two spacers 203 at equal distance. The polymeric tube 206 forms a return channel 207 for cooled heat exchange liquid. An inner coaxial channel 208 between polymeric tube 206 and inner tubular channel wall 204 forms a supply channel for heat exchange liquid. The inner coaxial channel 208 is divided by spacers 205 in four parallel equal channel parts 209. Between the outer cylinder wall 201 and the inner cylinder wall 204 is an outer coaxial channel 210 divided by the spacers 204, 205 in eight equal parallel channel parts 211. These channel parts 211 for a low pressure chamber for the re-collection of depressurized hydrogen gas.

FIG. 14 shows a variant which is similar to the one of FIG. 13. Same referential numbers are used for parts that are the same, in this embodiment, spacers 205 are of the same length as spacers 203. A polymer tube 215 is fitted into the interior of inner cylinder wall 204. Between this tube 215 and polymeric tube 206 is a supply channel 216 for heat exchange medium which is returned via the return channel 207 confined by polymeric tube 206.

The following gives an illustration of various embodiments of the present invention, without the invention being limited thereto or thereby.

### EXAMPLE 1

The high differential pressure electrochemical cell of present invention may incorporate several means to withstand high differential pressures including, a three layer membrane consisting of an electrically insulating ionic conductive layer sandwiched between two electrically and ionic conductive layers, reinforcement of said membrane layers by fibrous material and a microporous structure for supporting said membrane.

The three layer membrane 302 of FIGS. 3A and 3E for application in a ionic hydrogen gas compressor may be manufactured from three solutions/dispersions.

The dispersion for the electrically conductive ion-conductive layer 302A comprises KetjenBlack EC 600 provided with 1 weight percent platinum particles having a size in the range of 1-10 nm, preferably 2-5 nm to obtain catalytically active positions in the electrically conductive layer 302A to assist the ionisation of the molecular hydrogen. The dispersion further comprises a polymer, for example, Nafion® EW 1100, and a solvent.

The dispersion for the electrically insulating ion-conductive layer 302B comprises Aerosil® with an average particle size of 20 nm as non-conductive filler. The dispersion further comprises an ionomer, for example, Nafion® EW 1100, and a solvent.

The dispersion for the electrically conductive ion-conductive layer 302C comprises KetjenBlack EC 600 provided with 1 weight percent platinum particles having a size in the range of 1-10 nm, preferably 2-5 nm to obtain catalytically active positions in the electrically conductive layer 2C to assist the ionisation of the molecular hydrogen. The dispersion further comprises an ionomer, for example, Nafion® EW 1100, and a solvent.

Each dispersion is homogenized using a high shear high rotational speed Ultra Turax mixing device.

A slide-coat machine is provided with a Mylar type polyester carrier film with a thickness of 125 micron. Three supply vessels containing the above identified dispersions are connected to the slide-coat head of the machines and one or more dosing pumps control the supply ratio of the diverse dispersions to the Mylar film. Additionally the applied thin film layers can be reinforced with fibrous material such as (non) woven glass fibres. The machine is set to provide, for example, 1 metre of membrane per minute. The slide-coat head manufactures the three-layer membrane 302 in one operation. Subsequently, the membrane 302 is fed to a heating device to evaporate the solvents, taking care that the temperature is not so high that the properties of the membrane are affected, typically staving below the boiling temperature of the solvent.

The membrane produced according to example 1 can be processed into a CCM (Catalyst Coated Membrane) or MEA (Membrane Electrode Assembly) in manners known in the art for the manufacture of membrane-electrode assemblies. One known method is the application on both sides of the membrane of electrodes using the decal or transfer coating method. In this method a transfer film is coated with the electrodes. On one side of the membrane the anode on transfer film is pressed, and on the other side the transfer film with cathode coating is pressed. After pressing, heating, and cooling, the transfer films are removed. The remaining product is called a CCM, Catalyst Coated Membrane or MEA, Membrane Electrode Assembly.

This CCM or MEA is sandwiched between a macroporous electroconductive and mechanically rigid support structure which acts as a GDL (Gas Diffusion Layer) as known in the art. This support structure ads to the pressure resistance of said CCM or MEA.

This reinforced, three layered membrane sandwiched between two microporous supporting structures can be incorporated into an high pressure ionic hydrogen gas compressor or decompressor in a manner that will be evident to the skilled person.

### EXAMPLE 2

Alternative to Example 1 above, the three layer membrane 302 of FIGS. 3A and 3B may be manufactured from three solutions/dispersions as follows:

The dispersion for the electrically conductive ion-conductive layer 302A comprises KetjenBlack EC 600 provided with 1 weight percent platinum particles having a size in the range of 1-10 nm, preferably 2-5 nm to obtain catalytically active positions in the electrically conductive layer 302A to assist the ionisation of the molecular hydrogen. The dispersion further comprises a polymer, for example, Nafion® EW 1100, and a solvent.

The dispersion for the electrically insulating ion-conductive layer 2B comprises Aerosil® with an average particle size of 20 nm as non-conductive filler. The dispersion further comprises an ionomere, for example, Nafion® EW 1100, and a solvent.

The dispersion for the electrically conductive ion-conductive layer 302C oxygen evolution reaction catalyst particles, e.g. Iridium Oxide particles, having a size in the range of 1-100 nm, preferably 2-50 nm to obtain catalytically active positions in the electrically conductive layer 302A to assist the reaction of oxygen radicals with protons to form water. The dispersion further comprises ionomer, for example Nafion® EW 1100, and a solvent.

Each dispersion is homogenized using a high shear high rotational speed Ultra Turax mixing device.

A slide-coat machine is provided with a Mylar type polyester carrier film with a thickness of 125 micron. Three supply vessels containing the above identified dispersions are connected to the slide-coat head of the machines and one or more dosing pumps control the supply ratio of the diverse dispersions to the Mylar film. The machine is set to provide, for example, 1 metre of membrane per minute. The slide-coat head manufactures the three-layer membrane 302 in one operation. Subsequently, the membrane 302 is fed to a heating device to evaporate the solvents, taking care that the temperature is not so high that the properties of the membrane are affected, typically staying below the boiling temperature of the solvent.

The membrane produced according to this example can be processed into a CCM (Catalyst Coated Membrane) or MEA (Membrane Electrode Assembly) in manners known in the art for the manufacture of membrane-electrode assemblies. One known method is the application on both sides of the membrane of electrodes using the decal or transfer coating method. In this method a transfer film is coated with the electrodes. On one side of the membrane the anode on transfer film is pressed, and on the other side the transfer film with cathode coating is pressed. After pressing, heating, and cooling, the transfer films are removed. The remaining product is called a CCM, Catalyst Coated Membrane or MEA, Membrane Electrode Assembly. To this CCM or MEA a GDL (Gas Diffusion Layer) is added to the hydrogen side. A titanium mesh or foam is added to the oxygen forming side. This can be incorporated into an high pressure electrolyser in a manner known in the art. To ensure appropriate structural integrity it is possible for the CCM or MEA to be sandwiched between a microporous electroconductive and mechanically rigid support structure which acts as a GDL (Gas Diffusion Layer) as known in the art.

1. An electrochemical cell which encompasses a high pressure chamber and a low pressure chamber, said chambers being separated by a membrane, the membrane being ion-conductive and electrically insulating, the membrane having a first surface in the high pressure chamber and a second surface in the low pressure chamber, the first surface being provided with a first electrode, and the second surface being provided with a second electrode, the first and second electrodes being electroconductively connected to each other via an electric circuit, wherein the membrane comprises at least two ion-conductive layers such that at least one of said ion-conductive layers is electrically insulating and at least one of said ion-conductive layers is electrically conductive, the electrochemical cell being a high differential pressure electrochemical cell.

2. The electrochemical cell according to claim 1, wherein the membrane comprises an electrically insulating, ion-conductive layer interposed between a first electrically conductive ion-conductive layer and a second electrically conductive ion-conductive layer.

3. The electrochemical cell according to claim 1, wherein the membrane comprises at least one ion-conductive and electrically conductive layer, the layer comprising an ion-conductive matrix and an electrically conductive filler.

4. The electrochemical cell according to claim 3, wherein said electrically conductive filler comprises an electrically conductive network of particles within said ion-conductive matrix.

5. The electrochemical cell according to claim 3, wherein said electrically conductive filler is capable of attaching catalytic substances and/or has catalytic substances attached.

6. The electrochemical cell according to claim 1, wherein the at least one electrically conductive layer is made up of at least two layers such that, of the at least two layers, a layer closer to the electrode has a lower concentration of catalytically active material than a layer closer to the electrically insulating layer.

7. The electrochemical cell according to claim 1, wherein the electrically insulating layer contains a non-electrically conductive solid filler material.

8. The electrochemical cell according to claim 1, wherein the electrically insulating layer is profiled.

9. The electrochemical cell according to claim 1, wherein the at least one electrically conductive layer is made up of at least two layers such that, of the at least two layers, a layer closer to the electrode has a higher concentration of catalytically active material than a layer closer to the electrically insulating layer.

10. The electrochemical cell according to claim 1, wherein the pressure difference between the high pressure chamber and the low pressure chamber when the electrochemical cell is in use is at least 1 MPa.

11. The electrochemical cell according to claim 1, the electrochemical cell being either an ionic gas compressor or an ionic gas decompressor, wherein, when the electrochemical cell is in use,
when the electrochemical cell is the ionic gas compressor, the high pressure chamber contains a hydrogen gas and the low pressure chamber contains a hydrogen-containing gas, and
when the electrochemical cell is the ionic gas decompressor, the high pressure chamber contains a the hydrogen-containing gas and the low pressure chamber contains hydrogen.

12. The electrochemical cell according to claim 1, the electrochemical cell being an electrolyser, wherein, when the electrochemical cell is in use, the high pressure chamber contains hydrogen and the low pressure chamber contains water.

13. (canceled)

14. (canceled)

15. (canceled)

16. A process for compressing hydrogen using an electrochemical cell which encompasses a high pressure chamber and a low pressure chamber, said chambers being separated by a membrane, the membrane being ion-conductive and electrically insulating, the membrane having a first surface in the high pressure chamber and a second surface in the low pressure chamber, the first surface being provided with a first electrode, and the second surface being provided with a second electrode, the first and second electrodes being electroconductively connected to each other via an electric circuit, the membrane comprising at least two ion-conductive layers such that at least one of said ion-conductive layers is electrically insulating and at least one of said ion-conductive layers is electrically conductive, the electrochemical cell being a high differential pressure electrochemical cell, the process comprising:
feeding hydrogen-containing gas to the low pressure chamber, and
providing an electric current to the electric circuit, whereby hydrogen is compressed into the high pressure chamber through the membrane.

17. A process for decompressing hydrogen using an electrochemical cell which encompasses a high pressure chamber and a low pressure chamber, said chambers being separated by a membrane, the membrane being ion-conductive and electrically insulating, the membrane having a first surface in the high pressure chamber and a second surface in the low pressure chamber, the first surface being provided with a first electrode, and the second surface being provided with a second electrode, the first and second electrodes being electroconductively connected to each other via an electric circuit, the membrane comprising at least two ion-conductive layers such that at least one of said ion-conductive layers is electrically insulating and at least one of said ion-conductive layers is electrically conductive, the electrochemical cell being a high differential pressure electrochemical cell, the process comprising:
feeding hydrogen-containing gas to the high pressure chamber, and
drawing an electric current from the electric circuit, whereby hydrogen is decompressed into the low pressure chamber and electric current is generated.

18. A process for converting water into hydrogen and oxygen using an electrochemical cell which encompasses a high pressure chamber and a low pressure chamber, said chambers being separated by a membrane, the membrane being ion-conductive and electrically insulating, the membrane having a first surface in the high pressure chamber and a second surface in the low pressure chamber, the first surface being provided with a first electrode, and the second surface being provided with a second electrode, the first and second electrodes being electroconductively connected to each other via an electric circuit, the membrane comprising at least two ion-conductive layers such that at least one of said ion-conductive layers is electrically insulating and at least one of said ion-conductive layers is electrically conductive, the electrochemical cell being a high differential pressure electrochemical cell, the process comprising:
feeding water to the low pressure chamber,
providing an electric current to the electric circuit,
withdrawing oxygen from the low pressure chamber, and
withdrawing hydrogen from the high pressure chamber.

19. The electrochemical cell according to claim 1, wherein the membrane is proton conductive.

20. The electrochemical cell according to claim 8, wherein the electrically insulating layer is profiled in the form of a regular or irregular wave or saw pattern, or in any other non-flat profile.
